(19) United States
(12) Patent Application Publication
(10) Pub. No.: US 2025/0021860 A1
(43) Pub. Date: Jan. 16, 2025

(54) MANAGING PROCESSING OF QUANTUM CIRCUITS

(71) Applicant: ColdQuanta, Inc., Boulder, CO (US)

(72) Inventors: Kaitlin Nicole Smith, Chicago, IL (US); Frederic Tsyh-An Chong, Chicago, IL (US); Pranav Gokhale, Chicago, IL (US); Michael Alexandrovich Perlin, Chicago, IL (US)

(73) Assignee: ColdQuanta, Inc., Boulder, CO (US)

(21) Appl. No.: 18/418,848

(22) Filed: Jan. 22, 2024

Related U.S. Application Data
(60) Provisional application No. 63/441,580, filed on Jan. 27, 2023.

(51) Int. Cl. G06N 10/80

(52) U.S. Cl. CPC G06N 10/80

(57) ABSTRACT

A method comprises determining a first and second portion of a quantum circuit specification based at least in part on two or more estimated gate simulation times associated with simulating two or more quantum gate operations; generating a first set of output quantum states (OQSs) by simulating the first portion using a classical processor; determining a first set of measurement results associated with the first set of OQSs; generating a second set of OQSs by simulating or executing the second portion; determining a second set of measurement results associated with the second set of OQSs; and determining a result based at least in part on the first set of measurement results and the second set of measurement results; where the first set of OQSs and the second set of OQSs do not depend on each other.

### CROSS-REFERENCE TO RELATED APPLICATION(S)

This application claims priority to and the benefit of U.S. Provisional Application Ser. No. 63/441,580, entitled “MANAGING PROCESSING OF QUANTUM CIRCUITS,” filed Jan. 27, 2023, which is incorporated herein by reference.

### STATEMENT AS TO FEDERALLY SPONSORED RESEARCH

This invention was made with government support under Grant No. DE-SC0021526 awarded by the US Department of Energy. The government has certain rights in the invention.

### TECHNICAL FIELD

This disclosure relates to managing processing of quantum circuits.

### BACKGROUND

Quantum computing is an emerging information processing paradigm that shows great promise for applications such as chemistry, optimization, cryptography, and machine learning, among others. Because quantum bits, or qubits, have the ability to demonstrate quantum superposition, interference, and entanglement, quantum algorithms enable significant speedups when applied toward certain classes of problems, such as problems characterized by a large search space in which the optimal solution resides.

There are various kinds of quantum processors that allow for quantum computation with any of a variety of types of quantum processing elements that can individually or collectively store quantum states. Different physical systems that can be used to implement quantum processing elements within a quantum computing system include trapped ions, superconducting circuits, neutral atoms, NV-centers, and photonics. The quantum processing elements are sometimes referred to as qubits of the quantum processor, and the collection of quantum processing elements are sometimes referred to as a quantum register of the quantum processor. Trapped ion quantum computing can utilize electromagnetic fields to trap charged atomic particles-ions. Neutral atom quantum computing can utilize an array of laser light to trap cold atoms. In both trapped ions and neutral atoms, the atomic levels of the ions or atoms can be used as the qubits for quantum computation. Once ions or atoms are confined, their two or more atomic levels can be coupled via laser light, thus allowing one to perform a set of quantum operations. For trapped ions, the motion of the ions may be altered by laser light, and through the Coulomb force, one may quantum mechanically entangle two or more ions. For neutral atoms, a Rydberg blockade may allow for quantum mechanical entanglement across two or more atoms. Some physical systems may allow for the representation of quantum states based on more than two basis states, which can be referred to as quantum digits, also called “qudits.” The techniques described herein with respect to quantum states expressed in qubits can also be implemented using quantum states expressed in qudits.

### SUMMARY

In one aspect, in general, a method for determining a computational result associated with execution of a quantum circuit specification specifying quantum gate operations applied to quantum states associated with respective quantum processing elements comprises: determining a first portion and a second portion of the quantum circuit specification based at least in part on two or more estimated gate simulation times associated with simulating two or more quantum gate operations in the quantum circuit specification; generating a first set of one or more output quantum states by simulating the first portion of the quantum circuit specification one or more times using a classical processor; determining a first set of one or more measurement results associated with the first set of one or more output quantum states; generating a second set of one or more output quantum states by simulating the second portion of the quantum circuit specification one or more times using the classical processor or by executing the second portion of the quantum circuit specification one or more times using a quantum processor; determining a second set of one or more measurement results associated with the second set of one or more output quantum states; and determining the computational result associated with execution of the quantum circuit specification based at least in part on the first set of one or more measurement results and the second set of one or more measurement results; where the first set of one or more output quantum states do not depend on the second set of one or more output quantum states, and the second set of one or more output quantum states do not depend on the first set of one or more output quantum states.

Aspects can include one or more of the following features.

The method further comprises determining one or more modifications to parameters associated with one or more quantum gate operations in the quantum circuit specification based at least in part on the computational result.

Where the determining of one or more modifications to parameters associated with one or more quantum gate operations in the quantum circuit specification comprises optimizing a function using a classical processor.

Where a first estimated circuit simulation time associated with simulating the first portion of the quantum circuit specification is less than a second estimated circuit simulation time associated with simulating the second portion of the quantum circuit specification.

Where the first portion of the quantum circuit specification comprises a first number of quantum processing elements and a second number of quantum gate operations, and the second portion of the quantum circuit specification comprises a third number of quantum processing elements and a fourth number of quantum gate operations.

Where the first estimated circuit simulation time corresponds to a polynomial time that is upper bounded by a polynomial expression in at least one of (1) the first number of quantum processing elements or (2) the second number of quantum gate operations, and the second estimated circuit simulation time corresponds to an exponential time that is upper bounded by an exponential expression in at least one of (1) the third number of quantum processing elements or (2) the fourth number of quantum gate operations.

Where the second number of quantum gate operations is more than double the fourth number of quantum gate operations.

Where a first estimated gate simulation time of the two or more estimated gate simulation times is associated with one or more Clifford quantum gate operations, and a second estimated gate simulation time of the two or more estimated gate simulation times is associated with one or more non-Clifford quantum gate operations.

Where the first portion of the quantum circuit specification consists of Clifford quantum gate operations, and the second portion of the quantum circuit specification comprises one or more non-Clifford quantum gate operations.

Where at least a portion of the quantum circuit specification comprises an error correcting code.

Where the error correcting code comprises both Clifford quantum gate operations and non-Clifford quantum gate operations.

Where at least a portion of the quantum circuit specification comprises a set of one or more noise modeling quantum gate operations corresponding to one or more noise models.

Where the second portion of the quantum circuit specification comprises a subset of noise modeling quantum gate operations from the set of one or more noise modeling quantum gate operations that are non-Clifford quantum gate operations.

The method further comprises comparing two sequences of data based at least in part on the computational result.

Where the determining of the first set of one or more measurement results associated with the first set of one or more output quantum states comprises simulating at least one X basis measurement, Y basis measurement, or Z basis measurement.

The method further comprises inserting one or more state preparation quantum gate operations in the second portion of the quantum circuit.

Where the generating of the second set of one or more output quantum states comprises executing the second portion of the quantum circuit specification one or more times using the quantum processor.

Where a first quantum gate operation in the first portion of the quantum circuit specification and a second quantum gate operation in the second portion of the quantum circuit specification are each applied to a common quantum processing element in the quantum circuit specification.

The method further comprises determining a first statistical model based at least in part on the first set of one or more measurement results and determining a second statistical model based at least in part on the second set of one or more measurement results.

Where the determining of the first set of one or more measurement results comprises modeling a probability associated with a measured quantum state associated with the first set of one or more output quantum states using a multinomial distribution.

The method further comprises removing a third portion of the quantum circuit specification based at least in part on the first set of one or more measurement results.

Where the first set of one or more measurement results comprises a basis measurement of a quantum state that is equal to zero.

In another aspect, in general, a system comprises: a machine-readable storage medium storing a quantum circuit specification specifying quantum gate operations applied to quantum states associated with respective quantum processing elements; at least one classical processor in communication with the machine-readable storage medium and configured to process the quantum circuit specification, the processing comprising: determining a first portion and a second portion of the quantum circuit specification based at least in part on two or more estimated gate simulation times associated with simulating two or more quantum gate operations in the quantum circuit specification, generating a first set of one or more output quantum states by simulating the first portion of the quantum circuit specification one or more times, determining a first set of one or more measurement results associated with the first set of one or more output quantum states, and determining a computational result associated with execution of the quantum circuit specification based at least in part on the first set of one or more measurement results and a second set of one or more measurement results; and at least one quantum processor comprising quantum processing elements and configured to process the second portion of the quantum circuit specification, the processing comprising: generating a second set of one or more output quantum states by executing the second portion of the quantum circuit specification one or more times, and determining the second set of one or more measurement results associated with the second set of one or more output quantum states; where the first set of one or more output quantum states do not depend on the second set of one or more output quantum states, and the second set of one or more output quantum states do not depend on the first set of one or more output quantum states.

Aspects can include the following feature.

Where a first estimated circuit simulation time associated with simulating the first portion of the quantum circuit specification is less than a second estimated circuit simulation time associated with simulating the second portion of the quantum circuit.

Aspects can have one or more of the following advantages.

The subject matter disclosed herein includes various implementations of a quantum circuit processing and simulation protocol (QCPSP) that can be used for high fidelity and scalable quantum circuit processing and simulation. The QCPSP can be a useful tool for architects and quantum practitioners, who may apply it to study near-Clifford circuits pertinent to error correction design, variational quantum algorithms (VQAs), and end-user applications. In some examples, the QCPSP can be utilized in quantum comparing protocols (QCPs) that can generate fingerprints for sequences of data. Additional commercial benefit of the QCPSP may be found by applying it beyond local simulators to running on classical accelerators (e.g., GPUs or TPUs) or on physical (i.e., non-simulated) quantum hardware.

In some examples, the QCPSP can be used to deliver a near-Clifford quantum circuit simulator that helps fill the gap that exists between approximate and realistic noisy quantum error correction simulation. Furthermore, the QCPSP can be used for near-Clifford variational optimization with a near-CAFQA ansatz initialization framework. In general, Clifford circuits can exhibit quantum advantages for generative modeling machine learning tasks. However, a challenge is to train these machine learning models, which may require non-Clifford gates. The QCPSP can be used in this context of primarily Clifford gates, with the addition of non-Clifford gates to enable gradient descent in the parameter landscape.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is a schematic diagram of an example quantum computing system.

FIG. 1B is a schematic diagram of an example hybrid quantum-classical computing system.

FIG. 1C is a schematic diagram of an example classical computing system.

FIG. 2 is a schematic diagram of an example quantum circuit modified by the QCPSP.

FIG. 3 is a plot of simulation time as a function of the number of qubits, for a variety of simulators.

FIG. 4 is a plot of simulation time as a function of the number of HWEA rounds, for two simulators.

FIG. 5 is a plot of simulation time as a function of the number of qubits.

FIG. 6 is a plot of simulation time as a function of the number of qubits, for a variety of simulators.

FIG. 7 is a flowchart of an example QCPSP.

### DETAILED DESCRIPTION

Quantum computing has the potential to provide exponential speedups over classical computing for many important applications. However, current quantum computers are in their early stages, and hardware quality issues can hinder the scale of program execution. Benchmarking and simulation of quantum circuits on classical computers is therefore useful to advance the understanding of how quantum computers and programs operate, enabling both algorithm discovery that leads to high-impact quantum computation and engineering improvements that deliver more powerful quantum systems. The nature of quantum information, however, often causes simulation complexity to scale exponentially with problem size. As used herein, the term “classical” with respect to hardware refers to computing circuitry or other hardware that does not include quantum processing elements that are specifically configured to represent associated quantum states; and “classical” with respect to software refers to computing instructions or other software configured for execution on classical hardware or a classical portion of a hybrid quantum-classical computing system.

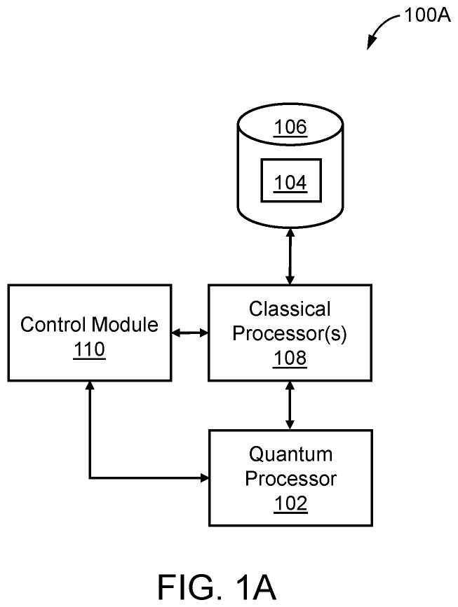

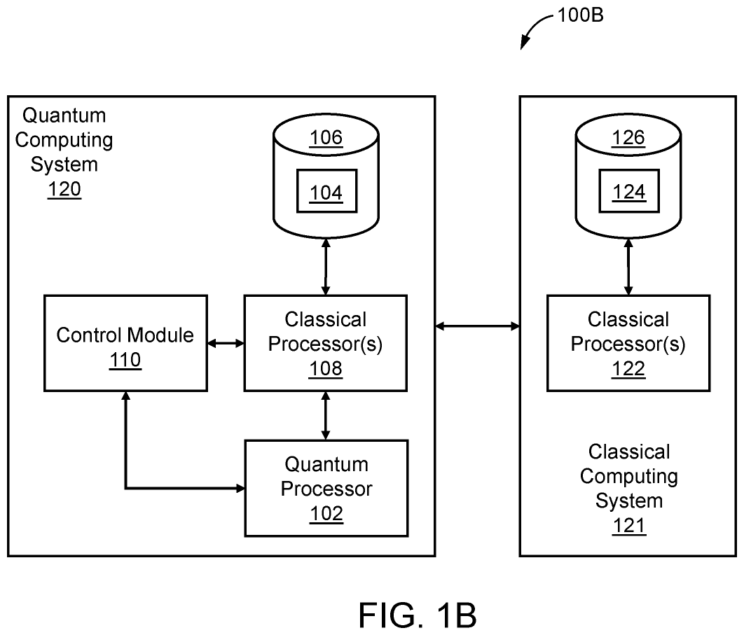

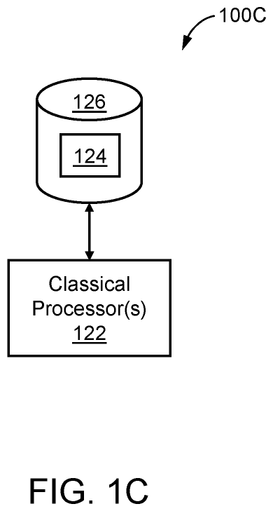

FIG. 1A shows an example quantum computing system 100A that includes a quantum processor 102 comprising a plurality of quantum processing elements (not shown) associated with respective quantum states. The quantum processor 102 is configured to apply quantum gate operations (also referred to simply as “gates”) comprising coupling operations (e.g., multi-qubit operations) and transformation operations (e.g., single-qubit operations) to a plurality of the quantum states according to a quantum circuit specification 104, stored on a storage medium 106, that specifies a schedule for a plurality of quantum gate operations applied to respective quantum processing elements. One or more classical processors 108 are in communication with the quantum processor 102, the storage medium 106, and a control module 110. The classical processors 108 can be configured to receive information based at least in part on measurements of one or more quantum states associated with respective quantum processing elements of the quantum processor 102, and provide information for preparing one or more quantum states associated with respective quantum processing elements of the quantum processor 102 based at least in part on the received information or the quantum circuit specification 104. The control module 110 is in communication with the quantum processor 102 and is configured to control the applied coupling and transformation operations based on interactions with the classical processors 108. The applied coupling and transformation operations may be performed, for example, by using radio frequency electromagnetic fields coupled to a coupled array of superconducting circuits, or by using optical or radio frequency electromagnetic fields coupled to atoms or ions.

Referring again to FIG. 1A, the classical processors 108 can be responsible for a variety of tasks and can be implemented in any of a variety of configurations. For example, the classical processors 108 can include one or more processor cores, each comprising (1) at least one CPU or at least one GPU and (2) other circuitry, such as local cache memory for data or instructions. When there are multiple processor cores, there can be a bus or an interconnection network among the processor cores. Alternatively, the classical processors 108 can be implemented using a field programmable gate array (FPGA) or other programmable circuitry, such as an application specific integrated circuit (ASIC). There may also be a memory system that includes volatile memory, such as dynamic random-access memory (DRAM) modules, or non-volatile memory, such as a solid-state drive (SSD). Interface devices for interacting with the classical processors 108 can include any of a variety of communication ports for coupling to a variety of communication channels, including electronic, optical, or wireless communication channels. In some cases, the classical processors 108 can be integrated with or locally coupled to the quantum processor 102. In some cases, the quantum processor 102 or the classical processors 108 can be accessed from a client device in communication with a server over a network connection. In some examples the storage medium 106 stores a QCPSP such that the classical processors 108 can perform at least a portion of the QCPSP on a chosen quantum circuit specification.

FIG. 1B shows an example hybrid quantum-classical computing system 100B that includes a quantum computing system 120 in communication with a classical computing system 121. The classical computing system 121 comprises one or more classical processors 122 in communication with a storage medium 126 that stores a QCPSP 124. Such a hybrid quantum-classical computing system 100B can be used to execute programs that use both classical computer instructions for some portions of the program and quantum circuit specifications for other portions of the program, and may be configured to iterate between the classical and quantum portions. In some examples, the classical processors 122 can perform at least a portion of the QCPSP 124 on a chosen quantum circuit specification. Portions of the chosen quantum circuit specification can then be transmitted to the quantum computing system 120 and executed on the quantum processor 102. In some examples, the quantum computing system 120 and the classical computing system 121 are in direct communication over local hardware (e.g., a serial or parallel data bus), while in other examples they are in communication over a communication channel in a network (e.g., the Internet).

FIG. 1C shows an example classical computing system 100C comprising one or more classical processors 122 in communication with a storage medium 126 that stores a QCPSP 124. In some examples, the classical processors 122 can perform at least a portion of the QCPSP 124 on a chosen quantum circuit specification. Portions of the chosen quantum circuit specification can then be transmitted to a quantum computing system (e.g., the quantum computing system 100A of FIG. 1A) and executed on a quantum processor (e.g., the quantum processor 102 of FIG. 1A).

The subject matter disclosed herein includes various implementations of a quantum circuit processing and simulation protocol (QCPSP) that can be used for high fidelity and scalable quantum circuit processing and simulation. Some implementations of the QCPSP employ two techniques for accelerated quantum simulation: Clifford-based simulation and circuit cutting. Through the isolation of Clifford subcircuit fragments within a larger non-Clifford circuit, resource-efficient Clifford simulation can be invoked, thereby leading to significant reductions in runtime. After fragments are independently executed, circuit cutting and recombination procedures allow the final output of the original circuit to be reconstructed from fragment execution results.

The QCPSP disclosed herein can be useful for quantum practitioners by enabling quantum circuit evaluation to scale beyond the frontiers of current simulators. The results show that Clifford-based circuit cutting can accelerate the simulation of near-Clifford circuits, allowing hundreds of qubits to be evaluated with modest runtimes without sacrificing accuracy.

Quantum circuit simulation with classical hardware can offer an effective means to quantify performance and troubleshoot potential issues within quantum programs without needing direct access to quantum hardware. Through quantum circuit simulation, the computational power of quantum and classical computers can be distinguished, enabling the discovery of applications that have non-trivial quantum advantage. Additionally, quantum circuit simulators that faithfully reflect real machine noise can be a viable pathway to identifying quantum computer hardware features critical to the success of quantum algorithms, thereby leading to engineering improvements that deliver more powerful quantum systems. However, classical methods for quantum circuit simulation can suffer from scaling challenges that result from the exponential growth of resource requirements with the size of the quantum problem.

Due to the exponential scaling of Hilbert space dimension with the number of qubits in a quantum system, the classical description of quantum computation can be difficult. While this inability to easily translate many quantum computations into a classical equivalent enables quantum computers to demonstrate advantages when applied toward certain domains, it also hinders the understanding of large-scale quantum processing. However, not all classical simulation of quantum circuits is characterized by intractable scaling. If a quantum circuit is expressed with a special family of operations, known as Clifford operations, quantum simulation becomes efficient on classical hardware, with a classical simulation complexity that can grow quadratically (i.e., polynomially) with quantum system size. Some quantum circuits, such as Clifford circuits that do not comprise non-Clifford quantum gate operations, may be simulated in a polynomial time that is upper bounded by a polynomial expression in the number of qubits utilized in the quantum circuit. For example, a quantum circuit may have a number of qubits (i.e., circuit-width) of n, leading to a polynomial time that is upper bounded by a polynomial expression of n, such as n², n⁵, or n¹⁰. Other quantum circuits, such as quantum circuits comprising non-Clifford quantum gate operations, may be simulated in an exponential time that is upper bounded by an exponential expression in the number of qubits utilized in the quantum circuit. For example, a quantum circuit may have a number of qubits (i.e., circuit-width) of n, leading to an exponential time that is upper bounded by an exponential expression of n, such as 2ⁿ, 5ⁿ, or 8ⁿ. In general, the simulation time of a portion of a quantum circuit can be estimated based at least in part on the quantum gate operations it comprises. For example, quantum gate operations can be associated with estimated gate simulation times that can indicate the computational cost associated with the corresponding quantum gate operations. In some examples, quantum gate operations may be part of a class or group of quantum gate operations (e.g., Clifford quantum gate operations) that is known to have a specified range of estimated gate simulation times. In such examples, the estimated gates simulation times may be approximated to be the same for all quantum gate operations in the group of quantum gate operations. In general, precise estimates of the estimated gate simulation time are not necessary, and instead the corresponding time complexity of a quantum gate operation or a group of quantum gate operations may provide the information desired for estimating a simulation time of a portion of a quantum circuit. As disclosed herein, the QCPSP can selectively simulate one or more portions of a quantum circuit specification by determining an estimated circuit simulation time associated with each portion and by simulating portions below a threshold simulation time.

Various examples of a quantum circuit simulation utilizing a quantum simulator that performs both Clifford circuit simulation and circuit cutting are disclosed herein. Clifford circuit simulation is the efficient simulation of an important class of quantum circuits found in many critical quantum applications. Circuit cutting is a divide-and-conquer framework for simulating large quantum circuits by cutting them into smaller subcircuits. The subcircuits can be independently executed on smaller quantum computers, or executed using information and/or dependencies on other subcircuits. The disclosed quantum circuit processing and simulation techniques expand the set of quantum applications for which classical simulation is tractable and helpful.

Quantum circuit simulation, in some instances, may have overarching scale and structure limitations. Specifically, if a circuit requires k cuts to partition into Clifford and non-Clifford subcircuits, the reconstruction time, which scales as 4k, can be intractable. Despite this asymptotic limitation in the limit of a large number of cuts, it can be shown that in two example applications, the disclosed QCPSP offers orders-of-magnitude faster simulation over other approaches.

Without intending to be bound by theory, included herein is an overview of quantum computing fundamentals that may be useful for describing some example implementations. This overview is not all-inclusive.

An isolated qubit can hold a complex-valued linear combination (i.e., a superposition) of the basis states |0 [symbol] and |1 [symbol] . Upon measurement in the computational basis {|0 [symbol] , |1 [symbol] }, a qubit in the state |ψ [symbol] =α|0 [symbol] +β|1 [symbol] collapses onto a classical outcome of either |0 [symbol] or |1 [symbol] with probabilities |α|² and |β|², respectively. The states of an isolated qubit can be represented in vector notation with

$$\\ \vert 0 〉 = ( \begin{matrix}1 \\ 0\end{matrix} ) and \vert 1 〉 = ( \begin{matrix}0 \\ 1\end{matrix} ) .$$

A state of many qubits can be represented by tensor products of these vectors, as well as linear combinations of such tensor products. Quantum operations are represented by matrices U that transform state vectors. In ideal simulation of quantum computation, the quantum state magnitude is equal to one, ∥ψ [symbol] |²=1, and quantum operations are unitary, UU⁻¹=1, due to the conservation of energy.

Single-qubit operations frequently used in quantum computation include Rₓ(π)=X, R_{z}(π)=Z, and R_{y}(π)=Y, which cause a qubit bit-flip (an exchange of the probability amplitudes associated with the basis states), a phase-flip, and a combination of bit-flip and phase-flip, respectively. These operations, along with the identity gate I, are referred to as the Pauli operations or Pauli gates. When a Pauli operation has a control qubit, CX, CY, CZ, the two-qubit operation transforms the state of the target qubit with a Pauli rotation depending on the state of the control.

In the near term, one of the most promising applications for quantum computers are variational quantum algorithms (VQAs). In a VQA, a cost function is defined and encoded into a parameterized quantum circuit, referred to as an ansatz. VQAs can be thought of as hybrid quantum-classical algorithms where a classical optimizer tunes the ansatz parameters based on quantum circuit outcomes over many quantum computer evaluations, working toward a solution (i.e., the quantum state prepared by the quantum circuit) that either minimizes or maximizes a target cost function. VQAs have a wide range of applications, including quantum chemistry and optimization, and are well-poised for near-term demonstrations of quantum advantage because of their ability to adapt to the intrinsic noise profile of a quantum computer.

Quantum hardware may be limited in terms of baseline hardware error rates, or noise, and use one-to-one mappings between the logical qubits of quantum algorithms and the physical qubits in a quantum computer. However, many quantum algorithms, such as Shor's algorithm for quantum factoring and quantum algorithms that accelerate solving linear equations, may be extremely sensitive to noise, which can irreversibly corrupt the result of a computation. A central goal in quantum hardware design is therefore to achieve physical error rates below the thresholds required for fault-tolerant quantum error correction (QEC). In fault-tolerant QEC, a logical qubit is encoded into the state of many physical qubits, in such a way that physical errors can be diagnosed and corrected without corrupting the state of the logical qubit. Current quantum computing error rates are rapidly approaching, and have in some cases surpassed, the theoretical thresholds required to run the surface code (e.g., error rates of approximately 1%). Going forward, achieving useful, fault-tolerant, error-corrected quantum computation may require further reducing physical error rates, while simultaneously scaling up the number of qubits in quantum computing devices.

The Clifford Group is a set of quantum computing operations that transform Pauli operators into Pauli operators by conjugation. The Pauli operators are included in the Clifford Group, along with gates such as the CX,

$$\\ {R}_{x} ( \frac{π}{2} ) = \sqrt{X} , {R}_{z} ( π / 2 ) = \sqrt{Z} = S ,$$

and Hadamard (H) operations. Smaller qubit rotations that allow fine-grain control of the qubit state, such as R_{z}(π/4)=T, are non-Clifford operations (i.e., operations that are not within the Clifford Group). The Clifford Group does not provide a universal set of quantum gates and cannot be used for arbitrary quantum computation. However, there are important quantum domains that have applications focused on the Clifford-space, including quantum networks, error-correcting codes, teleportation, and error mitigation. Quantum states produced from Clifford circuits are referred to as stabilizer states.

The Gottesman-Knill theorem states that “Any quantum computer performing only: a) Clifford Group gates, b) measurements of Pauli group operators, and c) Clifford Group operations conditioned on classical bits, which may be the results of earlier measurements, can be perfectly simulated in polynomial time on a probabilistic classical computer”. In other words, restricting quantum circuits to only Clifford gates provides a means for scalable simulation, and this insight has been applied toward quantum circuit optimization such as dynamical decoupling scheduling and improved ansatz initialization for VQAs. While using only Clifford gates provides the advantage of tractable simulation, the use of a non-universal gate set during quantum computation may prohibit the quantum system from exploring the entire quantum state space.

In general, classical methods for quantum circuit simulation can suffer from scaling challenges. As algorithms increase in qubit count n (i.e., circuit width), resource requirements can grow exponentially, as 2ⁿ, to completely capture quantum state vector transformation. Even using high-performance supercomputers, high-precision simulation becomes prohibitively difficult as the number of qubits increases. For example, some classical quantum circuit simulations appear to be bounded at 61 qubits for quantum application circuits and, conditionally, 100 qubits for random quantum circuits. In addition, noisy simulation that attempts to model the coherence and quantum gate characteristics of real quantum hardware escalates the complexity of classical quantum circuit simulation even further. Size and uncertainty tradeoffs in quantum circuit simulation often create a gap between predicted quantum circuit outcomes and real machine performance that becomes challenging as classical quantum circuit simulation frontiers are approached.

Several approaches have been proposed for improving the viability of quantum circuit simulation on classical hardware, such as those based on state vector representation, Feynman path integrals, decision diagrams, ZX calculus, and tensor networks. Exact quantum simulators, such as state vector simulators, have especially poor scaling because they faithfully capture a quantum state in its entirety. Approximate simulators, such as tensor network simulators based on matrix product states, can exchange accuracy for scalability to produce outcomes with noise margins. Approximate methods can be exceedingly accurate in restricted scenarios, such as low entanglement or geometrically local entanglement, but these methods may fail outside their limited regimes of applicability.

Some estimates indicate that, at a minimum, millions of high-quality physical qubits may be required for fault-tolerant quantum computation. In fault-tolerant quantum computation, qubits can implement quantum error correcting codes, and since QEC circuits primarily consist of Clifford operations, classical simulation of n qubits executing QEC code cycles is possible in time poly (m, n), where m is the number of gates in the quantum circuit. The time complexity of poly (m, n) corresponds to a polynomial time that is upper bounded by a polynomial expression in at least one of (1) the number of quantum processing elements (i.e., n) or (2) the number of quantum gate operations (i.e., m), such as mn², m⁷n⁵, or n¹⁰ Quantum circuits including tens of thousands of qubits and millions of operations can be evaluated with Clifford simulation frameworks, such as Stim, a high-performance simulation framework for quantum stabilizer circuits. Clifford circuit simulators (e.g., Stim) can execute significantly faster than naïve non-Clifford simulators, such as state vector simulators (e.g., Cirq), especially as the number of qubits in the quantum circuit is increased. However, additional methods may be required to handle non-Clifford circuit elements during quantum circuit simulation. In a Clifford simulator, noise processes are Pauli channels, which can be thought of as probabilistic Pauli operations applied throughout a computation. If a more complex noise model is applied during simulation, namely a noise model that injects non-Clifford operations throughout a quantum circuit, the quantum circuit may lose its ability to be efficiently simulated as a whole.

The classical simulation complexity of quantum circuits scales polynomially according to the number of qubits and the number of Clifford gates but exponentially with the addition of each non-Clifford gate. Thus, one computational task of interest for quantum circuit simulation is to efficiently simulate near-Clifford circuits, or quantum circuits containing a few non-Clifford gates (e.g., T gates). For example, the Clifford+T gate set comprises quantum gate operations from the Clifford gate set and the T gate. Examples of Clifford+T simulators include techniques that use low-rank stabilizer decompositions and Monte Carlo sampling of stabilizer states. While the Clifford+T gate set provides a universal gate set for quantum computation, it may require many T gates to synthesize an arbitrary single-qubit gate, such as R_{z}(θ<π/4), to a high precision, which may significantly inflate the cost of simulation.

Circuit cutting is a technique that enables dividing a large quantum circuit into subcircuits, also referred to as fragments, that can be evaluated independently and recombined with classical postprocessing. The theory of circuit cutting relies on the ability to decompose arbitrary quantum operations into an orthonormal basis, such as the set of Pauli operations together with the identity operator, {1, X, Y, Z}. The mechanics of circuit cutting can involve identifying cuts that split a circuit into disjoint fragments, and evaluating the fragments either with a classical simulator or a quantum computer.

In general, Clifford subcircuits do not have to be cleanly separable: it is also possible to cut a non-Clifford gate from the middle of an otherwise Clifford circuit. Such a cut has the effect of increasing the size of a circuit fragment, but with the benefit of making the fragment efficiently simulable on a classical computer. If a cut appears at the end of a fragment, referred to as an out cut, the corresponding qubit may be measured in various bases. Similarly, if a cut appears at the beginning of a fragment, referred to as an in cut, the corresponding qubit may be prepared in a variety of initial states. As a consequence, each fragment may have a number of variants, where each variant corresponds to a fixed choice of initial states and measurement bases, that is exponentially large in the number of cuts that are incident to that fragment. Additionally, postprocessing fragment execution data to reconstruct the output of a quantum circuit can have a computational cost that grows exponentially, as 4k, with the number of cuts, k, making classical reconstruction of a quantum circuit intractable for large numbers of cuts.

When a quantum computer is targeted, some circuit cutting frameworks may optimize processing by optimizing the location of cuts to minimize the overhead of classical fragment recombination. Disclosed herein is an application of circuit cutting that can be used for the simulation of near-Clifford circuits or other circuits. Clifford circuits composed of thousands of qubits can be efficiently simulated on a classical computer, thus motivating quantum circuit simulation cut optimization that isolates non-Clifford gates. In a near-Clifford circuit, non-Clifford gates can be removed using a small number of cuts, and the resulting non-Clifford fragments can be small in terms of qubit and gate count, thereby allowing them to be rapidly evaluated even on exact classical simulators.

The example applications of the QCPSP disclosed herein are able to address the difficulty of simulating near-Clifford circuits. One example application applies to simulations for QEC and enables more accurate characterization and diagnosis of QEC under realistic noise models. Other example applications can enable end users of quantum computation to benchmark the capabilities of quantum hardware.

One application of simulating near-Clifford circuits is estimating the performance of a QEC circuit against a non-Clifford noise model. In particular, in order to numerically validate a fault-tolerant QEC code, one can run repeated simulations of QEC circuits with stochastic errors injected according to a physical noise model. Even with sophisticated tensor network methods, direct state vector or density matrix simulations have classical computing costs, as measured by both memory footprint and the number of floating-point operations, that scale exponentially with the number of qubits, thereby precluding the numerical investigation of error-correcting codes that involve more than a few dozen qubits.

One approach is therefore to perform stabilizer simulations. While these simulations are compatible with many typical error correcting codes, in that all gates are Clifford gates, the only errors that are supported in this model are Pauli errors, which are highly idealized and may not capture many physically relevant sources of error in a quantum computer. Prevalent noise channels, such as amplitude damping and overrotation, may not be captured by stabilizer simulations. Stabilizer-compatible approximations to these noise channels have been shown to substantially underestimate the impact of noise. For example, for a width-5 surface code lattice modeled with a systematic 1° overrotation noise, the estimated logical error rate is 10⁻¹⁶ based on a Pauli noise approximation, whereas the actual logical error rate is 10⁻⁶, ten orders of magnitude greater.

Thus, it can be beneficial to implement simulation approaches for QEC that can scale to hundreds of qubits without needing an approximated variant of the noise. In the case of Clifford QEC circuits, even adding a few non-Clifford gates to create a near-Clifford QEC description may improve modeling by creating a more granular picture of the impact error has on quantum computation. The disclosed QCPSP can be used to deliver a near-Clifford quantum circuit simulator that helps fill the gap that exists between approximate and realistic noisy QEC simulation.

VQAs are hybrid quantum-classical algorithms in which a classical optimization subroutine can make queries to a quantum computer in the form of gate parameters. The information the quantum computer sends as a response can then help inform the next quantum query of the classical optimizer. An ansatz is the parameterized quantum circuit used within the aforementioned feedback loop, and there are many ansatz structures that can be used within a VQA. Many ansatz quantum circuits are high-depth when mapped to hardware, which is not ideal for near-term quantum computers that are characterized by limited coherence windows for computation. The hardware efficient ansatz (HWEA) can provide a solution as it is customizable to a targeted quantum computer, making it low-depth and well-suited for near-term quantum hardware. At its core, the HWEA consists of single-qubit rotation gates, where the rotation angles are the tunable parameters, a layer of two-qubit entangling gates, and a final layer of single-qubit rotation gates. The expressiveness of a gate set of a quantum computer can allow a VQA to be more precise. In addition, more layers in the ansatz (e.g., comprising single-qubit rotations, entangling operations, and single-qubit rotations) can help boost VQA accuracy.

A challenging problem for the HWEA is determining initializion of the parameters at the start of VQA execution. Parameters can be randomly initialized, but finding approximately optimal angles for the single-qubit gates can help the VQA more rapidly and accurately converge on a desired answer. The Clifford Ansatz for Quantum Accuracy (CAFQA) uses an initial ansatz containing only Clifford operations and optimizes ansatz parameters with efficient Clifford simulation. This Clifford-based optimization for VQA can converge quickly and accurately to the desired VQA solution. However, the addition of just a single T gate allows the ansatz tuning space to become richer, opening doors for greater VQA accuracy. Thus, more optimal VQA initialization can result if a few non-Clifford gates are permitted in the VQA ansatz initialization via classical simulation. Unfortunately, the addition of a T gate to a Clifford circuit can make tractable scaling challenging, motivating the search for practical Clifford+T simulation solutions. With the disclosed QCPSP, new opportunities exist for near-Clifford variational optimization with a near-CAFQA ansatz initialization framework.

Clifford circuits can exhibit quantum advantages for generative modeling machine learning tasks. Typically, this advantage is quadratic, which coincides with the fact that classically simulating an n-qubit Clifford circuit requires tracking O(n²) stabilizer bits. Interestingly however, this quadratic advantage in memory can sometimes be lifted to a quartic O(n⁴) advantage in time, which has motivated deeper study of Clifford-based quantum speedups. However, a challenge is to train these machine learning models, which requires non-Clifford gates. The QCPSP can be used in this context of primarily Clifford gates, with the addition of non-Clifford gates to enable gradient descent in the parameter landscape.

Finally, the disclosed QCPSP can be applied to quantum comparing protocols (QCPs), such as SupercheQ. QCPs can perform the task of fingerprinting, which involves determining whether two files (i.e., sequences of data) are equal against a worst-case adversarial model that obviates even cryptographic hashes to avoid hash collisions. Using only Clifford circuits, QCP-IE (quantum comparing protocol, incremental encoding) asymptomatically matches the best possible classical protocol in space, while attaining a quantum advantage in terms of incrementality. Alternatively, QCP-EE (quantum comparing protocol, efficient encoding), which is entirely non-Clifford, attains an exponential advantage over the best possible classical protocol, though it lacks incrementality. Herein, the QCPSP is explored in the middle-ground region, in particular by enriching the Clifford-only space of QCP-IE with a few non-Clifford gates.

Motivated by the need for scalable quantum circuit simulation solutions and inspired by the performance of Clifford simulation, some examples of the QCPSP disclosed herein can use Clifford-based circuit cutting. In general, non-Clifford-based circuit cutting may also be performed to generate quantum circuit fragments that are efficiently simulable (e.g., quantum circuits that can be simulated in a polynomial time that is upper bounded by a polynomial expression in the number of qubits utilized).

The QCPSP can be written (i.e., coded) in any of a variety of software platforms that support quantum operations. For example, some of the implementations described herein are written using Python. The QCPSP can include a circuit cutting algorithm, a fragment evaluator, and a probability distribution reconstruction algorithm. In some examples, the QCPSP can use a simulator (e.g., Cirq) for representing and manipulating quantum circuits. In general, a quantum computer can be used for non-Clifford fragments.

In some examples, the circuit cutter begins the quantum circuit simulation flow and is the first transformer that an input quantum circuit encounters. The circuit cutter is a circuit parser that identifies the Clifford and non-Clifford elements within the quantum circuit. As input quantum circuits are intended to be near-Clifford, quantum circuit cuts can isolate the non-Clifford operations. After developing a set of cut locations, the original input quantum circuit is separated into disjoint subcircuits, which are referred to as quantum circuit fragments. The quantum circuit fragments are then sent to the quantum circuit simulation fragment evaluation module.

In some examples, all quantum circuit fragments can be tagged as either Clifford or non-Clifford. Clifford fragments are then passed to a Clifford circuit simulator (e.g., Stim), and non-Clifford fragments are passed to an exact simulator (e.g., a state vector simulator). Other examples can use other simulation back ends and state vector simulators. Each fragment induces several fragment variants, where one variant of a fragment corresponds to the fragment with some additional operations attached at the locations of cuts incident to that fragment. Fragment inputs and outputs are designated as follows.

Circuit Input: An input of the original, uncut circuit. All circuit input qubits can be initialized in the |0 [symbol] state, so no additional operations are associated with circuit inputs.

Circuit Output: An output of the original, uncut circuit. All circuit output qubits can be measured in the computational basis {|0 [symbol] , |1 [symbol] }, so no additional operations are required prior to measuring the circuit outputs on fragments.

Quantum Input: An input of the fragment, but not of the original circuit. Every quantum input is downstream of a cut in the original circuit. Additional operations may be required to prepare different states at quantum inputs.

Quantum Output: An output of the fragment, but not of the original circuit. Every quantum output is upstream of a cut in the original circuit. Additional operations may be required to measure quantum output qubits in different bases.

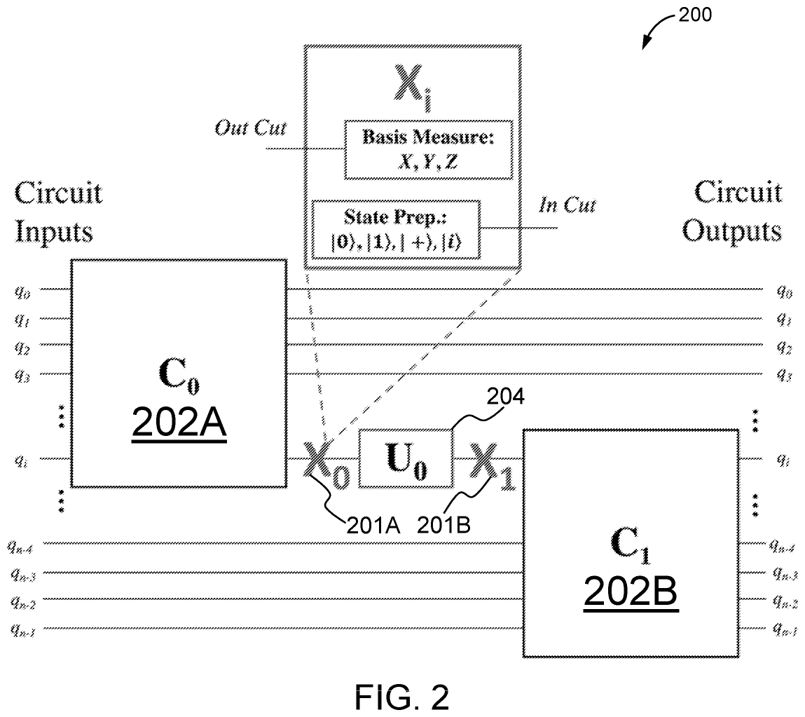

FIG. 2 shows an example near-Clifford quantum circuit 200 modified by the QCPSP. A first circuit cut 201A (X₀) and a second circuit cut 201B (X₁) isolate a first Clifford subcircuit 202A (C₀) and a second Clifford subcircuit 202B (C₁), respectively, from a non-Clifford operation 204 (U₀). The first circuit cut 201A and the second circuit cut 201B each comprise respective out cuts and respective in cuts. An out cut can include measuring one or more corresponding qubits in various bases, while an in cut can include preparing one or more corresponding qubits in a variety of initial quantum states.

After generating a batch of variants for each Clifford fragment, where one variant corresponds to a fixed choice of initial states and final measurement bases for that fragment, a simulator can determine the probability over measurement outcomes at the circuit outputs of each variant. These probability distributions can be tagged by associated choices of initial states and measurement bases can be classically postprocessed later to reconstruct a probability distribution over measurement outcomes for the original circuit. Some versions of quantum circuit simulation simulate fragment variants sequentially, while other versions of the QCPSP support parallel simulation strategies that may yield significant reductions in runtime.

In principle, tensor network methods can be used to collect all necessary non-Clifford fragment data directly without needing to simulate different fragment variants. Applications for which a significant fraction of classical computing resources is devoted to non-Clifford fragment simulation can utilize alternative implementations of the QCPSP that use a tensor network simulator for non-Clifford fragments.

The final component of the QCPSP combines fragment simulation data to build (i.e., reconstruct) the probability distribution outcomes of the original, uncut circuit using the measurement data of the fragment variants. One example of postprocessing fragment data first involves applying maximum-likelihood corrections to build fragment models that are self-consistent, thereby mitigating the effect of sampling error that is unavoidable in probabilistic Clifford simulation methods, as well as performing quantum circuit executions on real quantum hardware. After constructing self-consistent fragment models, individual probabilities for measurement outcomes in the original circuit can be expressed as the result of a tensor network contraction, with one tensor per fragment. This tensor network has a number of edges equal to the number of cuts in the original circuit, resulting in an overall computational cost to contraction that is roughly exponential in the number of cuts.

Performance of the QCPSP has been compared to the simulators available in Qiskit, IBM's open-source quantum software development kit, as well as the Cirq state vector simulator. The QCPSP builds a probability distribution from the fragment simulation results, and, as a result, all of the below simulators were used as samplers, where 5000 shots were used to build an output distribution for each experiment.

Qiskit QASM Simulator: A general-use simulator that supports a wide range of operations and noise models. Simulation method is chosen according to the input circuit and input parameters. As used herein, the QASM simulator was used for ideal simulation.

Qiskit Extended Stabilizer Simulator: A Clifford+T simulator. The extended stabilizer uses ranked-stabilizer decomposition and is approximate. Complexity scales with the number of non-Clifford gates as non-Clifford gates set the number of stabilizer terms. The T gate and R_{z}(θ) operations are included in the basis gate set. Up to 63 qubits are supported in a quantum circuit.

Qiskit Matrix Product State Simulator: A tensor-network simulator that relies on Matrix Product States (MPS). Tensor-network simulators, in general, are able to scale to larger quantum systems as compared to state vector simulators, at the cost of depth. Thus, this simulator can support more qubits than Qiskit QASM and extended stabilizer simulators as long as entanglement between qubits is low and critical path is small. A large gate set is supported.

Cirq Simulator: A state vector simulator that uses exact methods and is based on NumPy and sparse matrix representations.

Simulator performance was evaluated with working examples of simulation using two benchmark circuit types, with varying numbers of qubits. These circuits were chosen according to the applications proposed earlier in this disclosure.

Near-Clifford Hardware Efficient Ansatz: The near-Clifford HWEA is a helpful tool for VQA optimization. The base structure for this quantum circuit is a Clifford HWEA consisting of a single layer of single-qubit gates, a layer of entangling stages, and final layer of single-qubit gates. Together, these three layers of gates constitute a single layer of the HWEA. Circuit width (i.e., the number of qubits), and depth (i.e., the total number of layers), and non-Clifford gate injections were varied during experimentation.

Phase Flip Repetition Code: The repetition code is a classical error correcting code that constitutes an important precursor to QEC. In experiments evaluating the QCPSP performance for QEC applications, a single round of the phase code implementation was used as a benchmark.

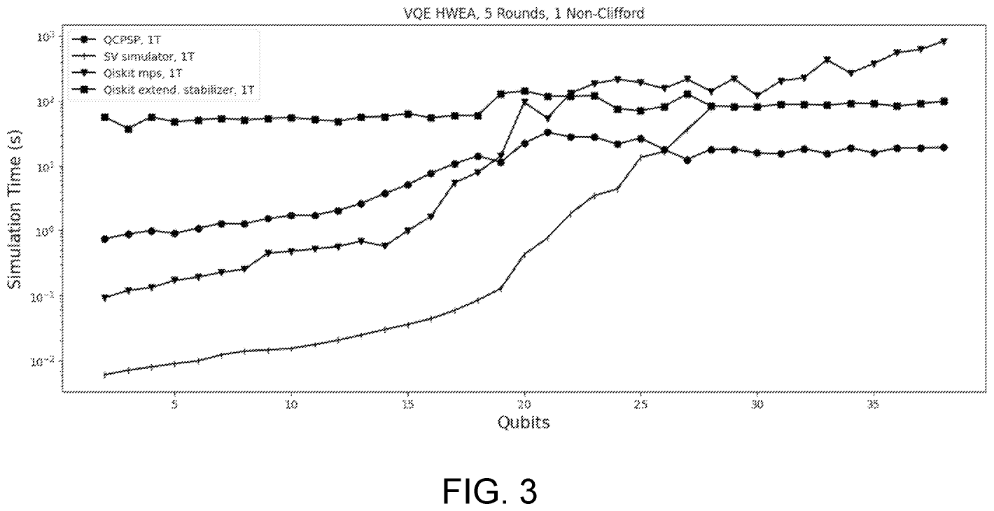

The QCPSP is a product targeted for a wide range of end users, from students in an academic setting to users in industry. In some examples, the QCPSP is designed for use on a personal computer. The working examples illustrated in the plots of FIGS. 3-6 compare results based on implementations of the QCPSP disclosed herein against other simulation techniques, and were generated using a MacBook Pro with a 2.4 GHz i9 Intel Processor and 32 GB of RAM.

Classical simulation of a near-Clifford HWEA can be applied toward the near-CAFQA framework. To begin, the relationships between simulation runtime and circuit width were analyzed in these working examples.

FIG. 3 shows plots of the simulation time as a function of the number of qubits in the HWEA benchmark for the QCPSP, the state vector (SV) simulator, the Qiskit extended stabilizer simulator, and the Qiskit matrix product state (MPS) simulator. The HWEA benchmark has five HWEA layers and one randomly injected T gate. Thus, each quantum circuit had five layers of entangling operations sandwiched between single-qubit parameterized (Clifford) operations. For smaller quantum circuits, the simulation time of the QCPSP is larger than all of the simulators by nearly an order of magnitude, with the exception of the Qiskit extended stabilizer simulator. However, for around 23 qubits and more, a crossover occurs such that the QCPSP becomes the most efficient simulator in terms of execution time.

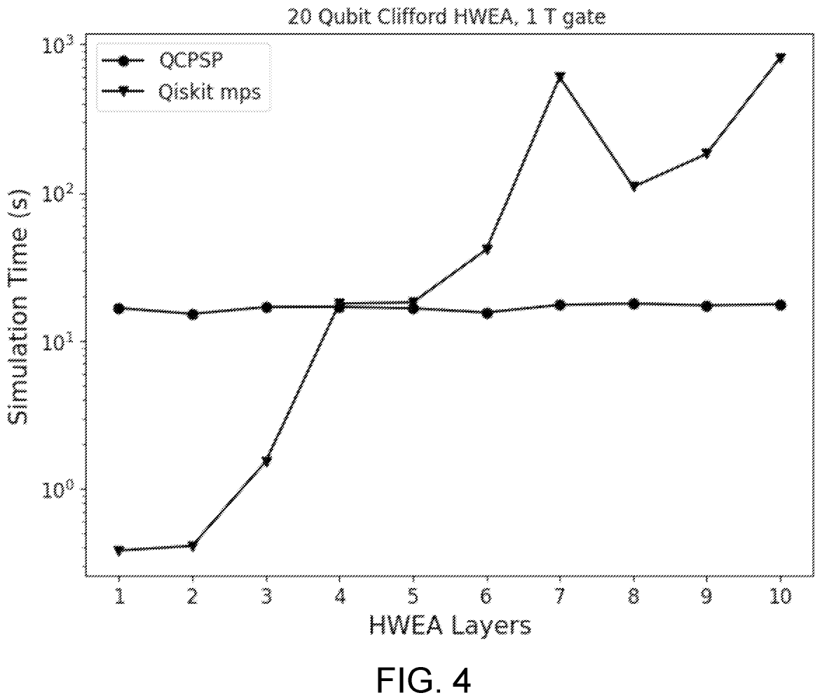

FIG. 4 shows plots of the simulation time as a function of the number of near-Clifford HWEA rounds for the QCPSP and the Qiskit MPS simulator. The near-Clifford HWEA has a fixed width of 20 qubits and a depth that varies from one to 10 layers (i.e., rounds) of the HWEA, in every case with one injected T gate. Thus, the QCPSP and the Qiskit MPS simulator performance are compared in a regime (i.e., a width of 20 qubits) where the Qiskit MPS simulator performed the best in FIG. 3. The QCPSP begins to demonstrate a strong advantage over the Qiskit MPS simulator at around 6 layers of the HWEA. Note that the QCPSP simulation time in this experiment is insensitive to the number of HWEA rounds because it spends the bulk of its time postprocessing fragment simulation data, rather than simulating fragments themselves.

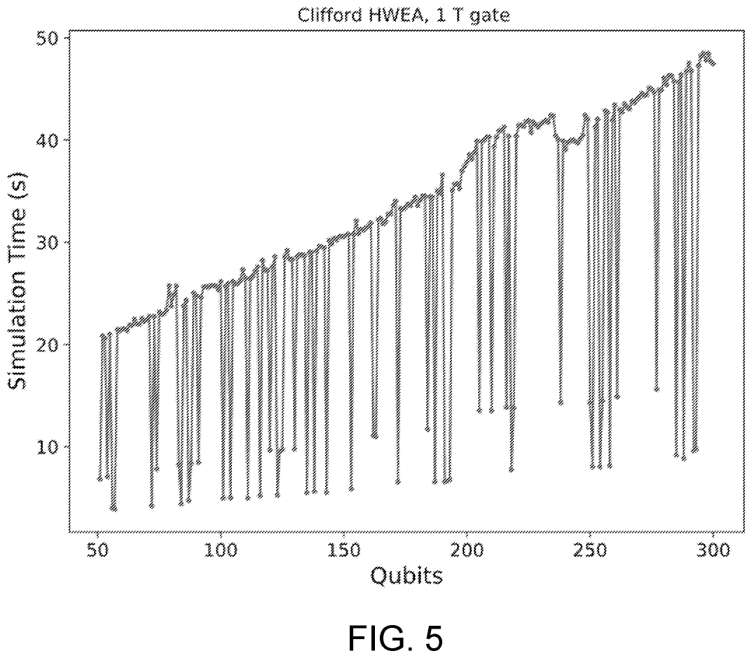

FIG. 5 shows a plot of the simulation time as a function of the number of qubits in the HWEA benchmark for the QCPSP. The HWEA benchmark has five HWEA layers and one randomly injected T gate, and ranges from 50 to 300 qubits. The results indicate that the QCPSP can simulate quantum circuits that are much larger than quantum circuits that are feasible with state vector and extended stabilizer simulators. Furthermore, the simulation times shown in FIG. 5 are all smaller than the simulation times with any other method at 31 qubits in FIG. 3. Note that the runtimes in FIG. 5 do not increase monotonically with qubit number. This is an artifact of simulating, for each number of qubits, only a single quantum circuit with a one randomly injected T gate. If a T gate happens to split a circuit into two Clifford subcircuits, for example, the resulting QCPSP simulation takes considerably less time than if a T gate is cut out of the middle of a single large Clifford circuit.

Next, the QCPSP performance was explored in the domain of QEC. Here, a phase repetition code benchmark was used to study runtime scaling with increasing qubit number.

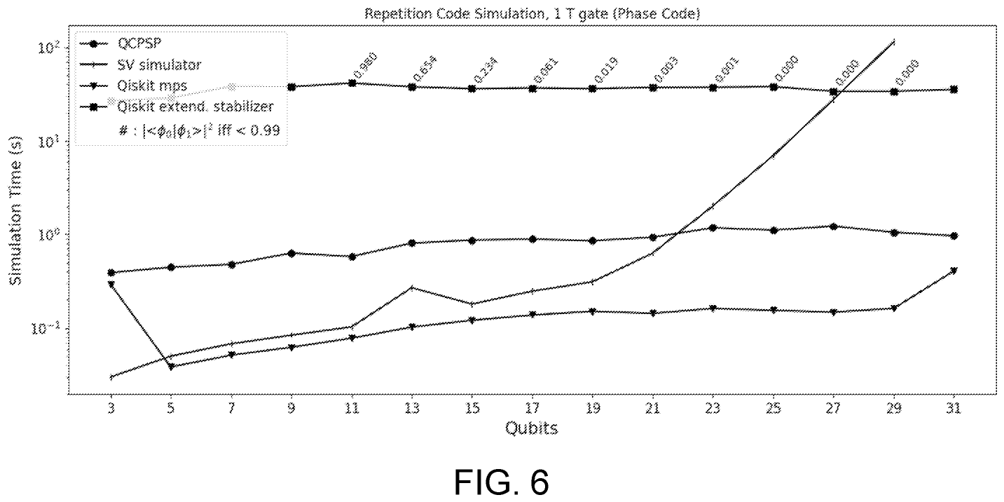

FIG. 6 shows plots of the simulation time as a function of the qubit number, for one round of the phase repetition code with one randomly injected T gate, for the SV simulator, the QCPSP, the Qiskit extended stabilizer simulator, and the Qiskit MPS simulator. To highlight a significant disparity in the accuracy of the extended stabilizer simulator, the fidelity of results against exact state vector simulations are also provided. On the plot, points are annotated where fidelity to state vector simulation results are less than 1.000 (with four significant digits). In other words, if a point on the curve does not have a label, its fidelity is greater than 0.999. As shown, the QCPSP scales favorably with qubit number, while most other simulators have poor runtime scaling and take longer than the QCPSP for more than 25 qubits. Moreover, the extended stabilizer simulator quickly becomes useless in terms of accuracy for the phase-repetition code. The use of the phase code is an artificial (i.e., proxy) benchmark that provides preliminary results for QEC circuit simulation, since it only addresses phase flip errors, not bit flip errors, and it detects errors without correcting them.

Referring again to FIG. 6, a potential exception to the favorability of the QCPSP over other methods is the MPS simulator, which outperforms the QCPSP for all numbers of qubits simulated. This exception is an artifact resulting from the fact that the quantum circuit for a phase repetition code cycle generates very little entanglement between the qubits involved. Whereas the QCPSP performance is unaffected by the degree of entanglement generated in a Clifford circuit, the MPS simulator is well-known to fail catastrophically in terms of simulation time, memory footprint, accuracy, or a combination of all three, depending on the precise implementation of the MPS simulator, in the regime of high and nonlocal (i.e., volume-law) entanglement. Near-future benchmarks that are more faithful to QEC simulation performance will involve codes that also correct bit-flip errors, and thereby require simulating highly entangled states that are simply out of reach for the MPS simulator.

The QCPSP combines the benefits of quantum circuit cutting and Clifford quantum circuit simulation. Knowing that both of these techniques suffer from their unique constraints, primarily exponential scaling with the number of cuts and limited application domain of Clifford-only circuits, respectively, the tradeoffs have been reduced by focusing on near-Clifford quantum circuits as targets for accelerated simulation. Although the quantum circuit evaluations shown in FIGS. 4, 5, and 6 injected T gates into the benchmarks, the circuit cutter of the QCPSP is able to identify, isolate, and create fragments for other non-Clifford gates, such as arbitrary R_{z}(θ) operations.

As shown in FIGS. 4 and 6, the QCPSP demonstrates significantly lower runtimes as the HWEA and repetition code benchmarks approach 30 qubits in size. The QCPSP outperforms the Qiskit extended stabilizer simulator, which is significant as this simulator is based on state-of-art Clifford+T simulation methods. In some cases, the QCPSP demonstrates runtime improvements of around 100× compared to the Qiskit extended stabilizer simulator and can be superior to Qiskit extended stabilizer in terms of accuracy. The QCPSP can scale to hundreds of qubits, and simulate these large quantum circuits in tens of seconds.

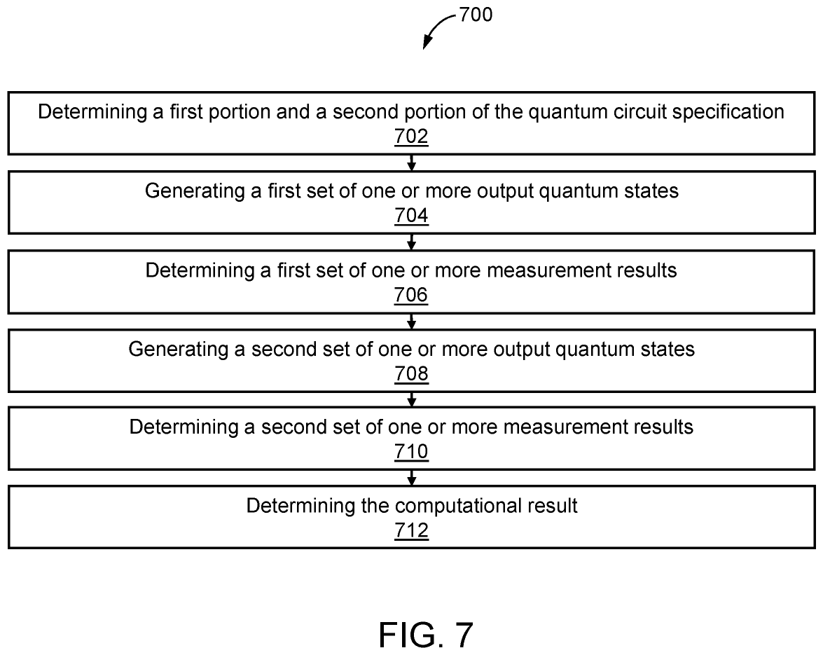

FIG. 7 shows a flowchart of an example QCPSP 700 for determining a computational result associated with execution of a quantum circuit specification specifying quantum gate operations applied to quantum states associated with respective quantum processing elements. The QCPSP 700 comprises determining a first portion and a second portion of the quantum circuit specification 702 based at least in part on two or more estimated gate simulation times associated with simulating two or more quantum gate operations in the quantum circuit specification. The QCPSP 700 further comprises generating a first set of one or more output quantum states 704 by simulating the first portion of the quantum circuit specification one or more times using a classical processor, and determining a first set of one or more measurement results 706 associated with the first set of one or more output quantum states. The QCPSP 700 further comprises generating a second set of one or more output quantum states 708 by simulating the second portion of the quantum circuit specification one or more times using the classical processor or by executing the second portion of the quantum circuit specification one or more times using a quantum processor. The QCPSP 700 further comprises determining a second set of one or more measurement results 710 associated with the second set of one or more output quantum states, and determining the computational result 712 associated with execution of the quantum circuit specification based at least in part on the first set of one or more measurement results and the second set of one or more measurement results. In the QCPSP 700, the first set of one or more output quantum states do not depend on the second set of one or more output quantum states, and the second set of one or more output quantum states do not depend on the first set of one or more output quantum states.

While the circuit cutting examples procedures described so far effectively leverage fast Clifford simulation at a per-subcircuit level, the procedure for stitching together results has thus far been agnostic to whether the subcircuits are Clifford or non-Clifford. As it turns out, breaking this abstraction barrier leads to substantial performance improvements. As a concrete example, consider a Clifford subcircuit Cᵢ upon which a cut qubit is measured in multiple bases (e.g., the first Clifford subcircuit 202A (C₀) of FIG. 2). Following the standard circuit cutting procedure, Pauli observable measurements [symbol] P [symbol] are made after running Cᵢ. Two Clifford-specific cutting optimizations that can be made are: (1) significantly fewer requisite shots and (2) fewer downstream stitching calculations.

The first optimization, fewer requisite shots, stems from the observation that for Clifford circuits, a measurement in a given basis, [symbol] P [symbol] , is either −1, 0, or +1 and may be modeled using a multinomial distribution, for example. After rotating to computational basis measurements, these correspond to being in the states |1 [symbol] , |+ [symbol] (or any other equal superposition), or |0 [symbol] , respectively. It turns out this significantly reduces the number of shots that are needed to determine [symbol] P [symbol] compared to generic estimation where accuracy would scale with the square root of the number of shots. By analogy, this setting is akin to being promised that there is a completely-biased heads coin (−1), fair coin (0), or completely-biased tails coin (+1). If the coin is flipped a few times and at least one heads and at least one tails are found, it can be determined that the coin is a fair coin. In the other two cases, only heads or only tails will be measured. In a similar fashion, in the quantum measurement setting, if just 10 shots are performed but measure |1 [symbol] (|0 [symbol] ) every time, it is statistically likely that [symbol] P [symbol] is −1 (+1).

The second optimization, fewer downstream stitching calculations, stems from the observation that in Clifford circuits, the output state must have [symbol] P [symbol] =0 for many Pauli observables. Consider the one-qubit case, where the six Clifford states belong on the Bloch octahedron. For each of these states, two of (X), (Y), and (Z) must be equal to 0. Plugging in zeros to the circuit cutting stitching equations, it can be shown that some of the “downstream” circuits that would otherwise need to be evaluated can be skipped. Moreover, this phenomenon scales favorably: for multi-qubit observables, the fraction of non-zero Pauli observables approaches 0, significantly reducing downstream calculations.

Optimizations, such as the first and second optimization, can readily be incorporated into the QCPSP and potentially provide computational complexity and runtime improvements. Furthermore, the following steps in the circuit cutting process are amenable to parallelization: parsing quantum circuits to find cut locations, simulating each variant associated with a fragment, and postprocessing the probability distributions generated by the aforementioned simulations in order to reconstruct the final probability distribution for the original circuit. Parallelizing these operations has been shown to reduce simulation costs for large circuits. The efficiency of the QCPSP can be further improved by implementing parallelization methods and leveraging the parallel processing power of GPUs and multi-core computing clusters.

The QCPSP can be used as a classical simulator of quantum circuits that can be based on Cirq and Stim simulation back ends. Different versions of the QCPSP can support additional fragment evaluation back ends, producing composite probability distributions that consist of results from a variety of technologies that include both real quantum computers and classical quantum circuit simulators. The QCPSP can cut circuits in order to maximize the size of Clifford circuits and minimize the size of non-Clifford circuits. These fragments can be simulated classically, but minor adjustments to the QCPSP can enable the non-Clifford circuits to be run on a real quantum computing machine. In alternative implementations, dynamic techniques can be used that identify circuit fragment and quantum machine/circuit simulator pairings, running fragment variants on the most resource-efficient back end.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for determining a computational result associated with execution of a quantum circuit specification specifying quantum gate operations applied to quantum states associated with respective quantum processing elements, the method comprising:
determining a first portion and a second portion of the quantum circuit specification based at least in part on two or more estimated gate simulation times associated with simulating two or more quantum gate operations in the quantum circuit specification;
generating a first set of one or more output quantum states by simulating the first portion of the quantum circuit specification one or more times using a classical processor;
determining a first set of one or more measurement results associated with the first set of one or more output quantum states;
generating a second set of one or more output quantum states by simulating the second portion of the quantum circuit specification one or more times using the classical processor or by executing the second portion of the quantum circuit specification one or more times using a quantum processor;
determining a second set of one or more measurement results associated with the second set of one or more output quantum states; and
determining the computational result associated with execution of the quantum circuit specification based at least in part on the first set of one or more measurement results and the second set of one or more measurement results;
where the first set of one or more output quantum states do not depend on the second set of one or more output quantum states, and the second set of one or more output quantum states do not depend on the first set of one or more output quantum states.

2. The method of claim 1, further comprising determining one or more modifications to parameters associated with one or more quantum gate operations in the quantum circuit specification based at least in part on the computational result.

3. The method of claim 2, where the determining of one or more modifications to parameters associated with one or more quantum gate operations in the quantum circuit specification comprises optimizing a function using a classical processor.

4. The method of claim 1, where a first estimated circuit simulation time associated with simulating the first portion of the quantum circuit specification is less than a second estimated circuit simulation time associated with simulating the second portion of the quantum circuit specification.

5. The method of claim 4, where the first portion of the quantum circuit specification comprises a first number of quantum processing elements and a second number of quantum gate operations, and the second portion of the quantum circuit specification comprises a third number of quantum processing elements and a fourth number of quantum gate operations.

6. The method of claim 5, where the first estimated circuit simulation time corresponds to a polynomial time that is upper bounded by a polynomial expression in at least one of (1) the first number of quantum processing elements or (2) the second number of quantum gate operations, and the second estimated circuit simulation time corresponds to an exponential time that is upper bounded by an exponential expression in at least one of (1) the third number of quantum processing elements or (2) the fourth number of quantum gate operations.

7. The method of claim 5, where the second number of quantum gate operations is more than double the fourth number of quantum gate operations.

8. The method of claim 1, where a first estimated gate simulation time of the two or more estimated gate simulation times is associated with one or more Clifford quantum gate operations, and a second estimated gate simulation time of the two or more estimated gate simulation times is associated with one or more non-Clifford quantum gate operations.

9. The method of claim 1, where the first portion of the quantum circuit specification consists of Clifford quantum gate operations, and the second portion of the quantum circuit specification comprises one or more non-Clifford quantum gate operations.

10. The method of claim 1, where at least a portion of the quantum circuit specification comprises an error correcting code.

11. The method of claim 10, where the error correcting code comprises both Clifford quantum gate operations and non-Clifford quantum gate operations.

12. The method of claim 1, where at least a portion of the quantum circuit specification comprises a set of one or more noise modeling quantum gate operations corresponding to one or more noise models.

13. The method of claim 12, where the second portion of the quantum circuit specification comprises a subset of noise modeling quantum gate operations from the set of one or more noise modeling quantum gate operations that are non-Clifford quantum gate operations.

14. The method of claim 1, further comprising comparing two sequences of data based at least in part on the computational result.

15. The method of claim 1, where the determining of the first set of one or more measurement results associated with the first set of one or more output quantum states comprises simulating at least one X basis measurement, Y basis measurement, or Z basis measurement.

16. The method of claim 1, further comprising inserting one or more state preparation quantum gate operations in the second portion of the quantum circuit.

17. The method of claim 1, where the generating of the second set of one or more output quantum states comprises executing the second portion of the quantum circuit specification one or more times using the quantum processor.

18. The method of claim 1, where a first quantum gate operation in the first portion of the quantum circuit specification and a second quantum gate operation in the second portion of the quantum circuit specification are each applied to a common quantum processing element in the quantum circuit specification.

19. The method of claim 1, further comprising determining a first statistical model based at least in part on the first set of one or more measurement results and determining a second statistical model based at least in part on the second set of one or more measurement results.

20. The method of claim 1, where the determining of the first set of one or more measurement results comprises modeling a probability associated with a measured quantum state associated with the first set of one or more output quantum states using a multinomial distribution.

21. The method of claim 1, further comprising removing a third portion of the quantum circuit specification based at least in part on the first set of one or more measurement results.

22. The method of claim 21, where the first set of one or more measurement results comprises a basis measurement of a quantum state that is equal to zero.

23. A system comprising:
a machine-readable storage medium storing a quantum circuit specification specifying quantum gate operations applied to quantum states associated with respective quantum processing elements;
at least one classical processor in communication with the machine-readable storage medium and configured to process the quantum circuit specification, the processing comprising:
determining a first portion and a second portion of the quantum circuit specification based at least in part on two or more estimated gate simulation times associated with simulating two or more quantum gate operations in the quantum circuit specification,
generating a first set of one or more output quantum states by simulating the first portion of the quantum circuit specification one or more times,
determining a first set of one or more measurement results associated with the first set of one or more output quantum states, and
determining a computational result associated with execution of the quantum circuit specification based at least in part on the first set of one or more measurement results and a second set of one or more measurement results; and
at least one quantum processor comprising quantum processing elements and configured to process the second portion of the quantum circuit specification, the processing comprising:
generating a second set of one or more output quantum states by executing the second portion of the quantum circuit specification one or more times, and
determining the second set of one or more measurement results associated with the second set of one or more output quantum states;
where the first set of one or more output quantum states do not depend on the second set of one or more output quantum states, and the second set of one or more output quantum states do not depend on the first set of one or more output quantum states.

24. The method of claim 23, where a first estimated circuit simulation time associated with simulating the first portion of the quantum circuit specification is less than a second estimated circuit simulation time associated with simulating the second portion of the quantum circuit.
